(19) United States
(12) Patent Application Publication
(10) Pub. No.: US 2011/0148201 A1
(43) Pub. Date: Jun. 23, 2011

(54) FUSE ELEMENT HAVING DAMPING STRUCTURE

(75) Inventor: Chia-Ming Chuang, Taipei (TW)

(73) Assignee: ATIEVA, INC., Redwood City, CA (US)

(21) Appl. No.: 12/972,518

(22) Filed: Dec. 20, 2010

(30) Foreign Application Priority Data
Dec. 18, 2009 (CN) 200910259532.6

(51) Int. Cl. H02J 1/00; H01H 85/02

(52) U.S. Cl. 307/43; 337/207

(57) ABSTRACT

A fuse element having a damping structure is disclosed. The fuse element includes a fuse body having two ends, a housing for encapsulating the fuse body and two extending anchor sections connected to the two ends. A meltable portion is coupled between the two ends and housed by the housing, so that the metable portion, when melted, will not contaminate the surrounding space. At least one of the anchor sections has at least one flexible conductive portion. If the fuse element is mounted in a circuit and subjected to shock and vibration, the flexible conductive portion will absorb the mechanical stresses placed on the terminals and the fuse body. As a result, the safety and reliability of the fuse element and the apparatus to which it is connected is significantly enhanced.

### FIELD OF THE INVENTION

The present invention relates to a fuse element, and more particularly, to a fuse element having a damping structure.

### DESCRIPTION OF THE RELATED ART

Concerns on rising oil prices and increasing carbon emissions have propelled auto makers to switch from gasoline to electric power in the auto market. However, the battery pack used in electric vehicles must pass strict environment tests and meet the crash safety standards under different road conditions, and must last for a long time. Therefore, connecting batteries in a safer way, maximizing the energy stored in batteries, prolonging the endurance of batteries and preventing batteries from forming thermal chain reactions in case of accident are key issues for developing the equipments of this type.

As shown in FIG. 1, a conventional battery module for use in an electric-powered vehicle usually includes a plurality of rectangular-shaped battery cells arranged as a matrix form and mounted in a box 1, wherein every battery cell 2 is oriented to expose the positive and negative electrodes thereof outside of the box 1. For clarity, the arrowed direction shown in FIG. 1 is defined to be a row direction and the direction perpendicular to the row direction is referred to as a column direction. Accordingly, a battery cell 2 is connected in series to an adjacent battery cell 2 in the row direction and connected in parallel to an adjacent battery cell 2 in the column direction. Every battery cell 2 is additionally connected in series to a fuse element 5, so as to protect it from the overload caused by a short circuit occurring when another battery cell is damaged. That is to say, when a certain battery cell in the battery module fails to function normally, the current flow from the rest of battery cells in the module will essentially cause a fuse element 5 connected to the damaged battery cell to melt down and fail open, so that the circuit to which the damaged battery cell is connected is interrupted to prevent the damaged battery cell from receiving external current and greatly reduces the possibility of thermal event. The damaged battery cell could have been caused by internal manufacturing defect within, or physical damage from outside in a crash event. In either case, the fuse element could serve to limit the possibility of thermal events such as fire or explosion.

A conventional fuse element 5, as shown in FIG. 2, includes a housing 51, a fuse body 52, and two extending anchor sections 53. The fuse body 52 is made of electrically conductive, low melting point material such as Zinc alloys and is housed by the housing 51 to protect the fuse body 52 from interference by moisture, dirt and grease. The fuse body 52 is electrically connected at both ends to two electrically conductive anchor sections 53. One of the anchor sections 53 is screw-connected to an electrode of the battery, while the other anchor section 53 is screw-connected to the circuit of the battery module.

Under a normal condition, an equivalent circuit of the circuit described above is shown in FIG. 3, in which the power Vcc provided by the battery 2 is output to an external load R_{L} via an internal resistor R_{I} and a fuse element 5 and finally grounded. When the battery pack is mounted in a vehicle, however, the fastened nuts tend to get loose over time due to the mechanical stresses created by vibration of the vehicle in motion. As shown in FIG. 4, a failure mechanism of loosening of screws at the positions where the anchor sections of the fuse element 5 are fastened to electrodes of a battery or other circuits leads to a poor contact which generates an extra equivalent resistance R_{A} at the loosened positions. The equivalent resistance R_{A} lowers the voltage across R_{L}, reducing output power of the system. Furthermore, the equivalent resistance R_{A} does not only consume the electric power provided by the battery, but also convert the consumed electric power P_{A} into heat energy according to the equation P_{A}=I×V_{A}. With the fastening nut getting more loosened and the R_{A} increased, the fuse element 5 eventually melted down by the heat generated by the equivalent resistance R_{A} at the loosened positions. There two additional failure mechanisms of the mechanical stress created by shock and vibration. The fuse element itself can be broken. Or the terminal to the battery cell 2 could have received enough stress to cause a break down of the seal between the cell terminal and the cell wall, greatly reducing cell life.

The fuse elements are initially provided to interrupt the circuit of a damaged battery cell, so as to allow the rest of the battery cells to work normally. However, they unexpectedly turn out to nullify themselves due to the shock and vibration of vehicles in traveling, and many functional batteries are forced to be disconnected from the battery pack. Failure mechanisms described above due to a long-term use of the vehicle would lead to a non-linear, abrupt increase in the accumulated amount of accidentally disconnected batteries. As a consequence, the battery pack is not longer able to provide power to drive the electric-powered vehicle and the vehicle fails eventually. Given the fact that a battery pack for use in an electric-powered vehicle is normally capable of providing electric power at a voltage or current level as high as several hundreds volts or several tens amperes, it is impossible for a driver to eliminate the problem of battery failure by performing a simple maintenance work. Such a problem would undesirably increase the risk of driving an electric-powered vehicle. Especially, motor vehicles must be compliant with strict safety inspection standards before coming into the market, and the battery defect described above is simply unacceptable.

Likewise, the fuse element for use in a circuit of a self-operational military equipment, such as a missile, or a self-operational outdoor test equipment would face the same type of mechanical stresses on the fuse element or the mounting points due to shock and vibration as well. Therefore, there exists a need for improving the connection between a fuse element and a battery or other circuit to ensure that the fuse element can reliably function under a shock and vibrating condition; otherwise, the reliability of an electric-powered vehicle, a self-operational outdoor equipment or a missile would be remarkably reduced. There are other battery cell over current protection mechanisms beside a fuse, such as positive temperature coefficient resistors. However, external mounted protection device with conventional stiff, inflexible mounting method suffer from the same failure mechanism. The present invention provides a solution in response to the need.

### SUMMARY OF THE INVENTION

Accordingly, a purpose of the present invention is to provide a fuse element, which has a damping structure and, therefore, is capable of absorbing mechanical stresses due to shock or vibrations.

Another purpose of the invention is to provide a fuse element having a damping structure, which ensures the reliability of fuse connection.

It is still another purpose of the invention to provide a power source module having a plurality of battery cells connected in series or in parallel, wherein each of the battery cell is connected to a reliable fuse element through which electric power is transmitted. By virtue of the protection provided by the fuse element, the malfunction of any of the battery cells due to internal or external means will not easily result in failure of the entire module.

The fuse element having a damping structure as disclosed herein comprises a fuse body including two ends and a meltable portion coupled between the two ends; a housing for encapsulating the fuse body; and two extending anchor sections, each being connected to one of the two ends. The at least one of the extending anchor sections has at least one flexible conductive portion.

A power source module provided with a fuse element according to the invention comprises: a plurality of energy storage units connected to one another in series or in parallel, each having two electrodes; and an electrically conductive circuit for being electrically connected to the two electrodes of the energy storage units to arrange the energy storage units in series or in parallel. The electrically conductive circuit is provided with the fuse element having a damping structure. The fuse element comprises: a fuse body including two ends and a meltable portion coupled between the two ends; a housing for encapsulating the fuse body; and two extending anchor sections, each being connected to one of the two ends. The at least one of the extending anchor sections has at least one flexible conductive portion.

Since the fuse element disclosed herein is provided with a damping structure which has a flexible conductive portion made of flexible conductive material, the flexible conductive portion will absorb the physical vibration energy after the fuse element is fastened at both ends, thereby improving the reliability of the connection at the ends of the fuse element. As a result, the fuse element is capable of function reliably under high shock and vibration environment.

Moreover, the power source module provided with the fuse element according to the invention is suitable for use in a system which involves management of an enormous quantity of energy and is frequently subjected to vibration, such as an electric-powered vehicle or an outdoor equipment. The invention ensures that all of the functional energy storage units are connected to the system and effectively disconnects un-functional energy storage units from the system. The invention provides a convenient solution for achieving the purposes described above.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram illustrating conventional battery cells arranged and positioned in a box;

FIG. 2 is a schematic diagram illustrating the structure of a conventional fuse element;

FIG. 3 is a circuit diagram showing that the fuse element of FIG. 2 is in an electrically connected state;

FIG. 4 is another circuit diagram showing that the fuse element of FIG. 3 is loosened from the fastened position, causing generation of extra resistance;

FIG. 5 is a schematic diagram showing that a fuse element having a damping structure according to the first preferred embodiment of the invention is connected to a battery cell;

FIG. 6 is an enlarged diagram showing the fuse element of FIG. 5;

FIG. 7 is a schematic diagram of the second preferred embodiment of the invention, showing that the battery cells are connected in parallel; and

FIG. 8 is an enlarged diagram showing the fuse element of FIG. 7.

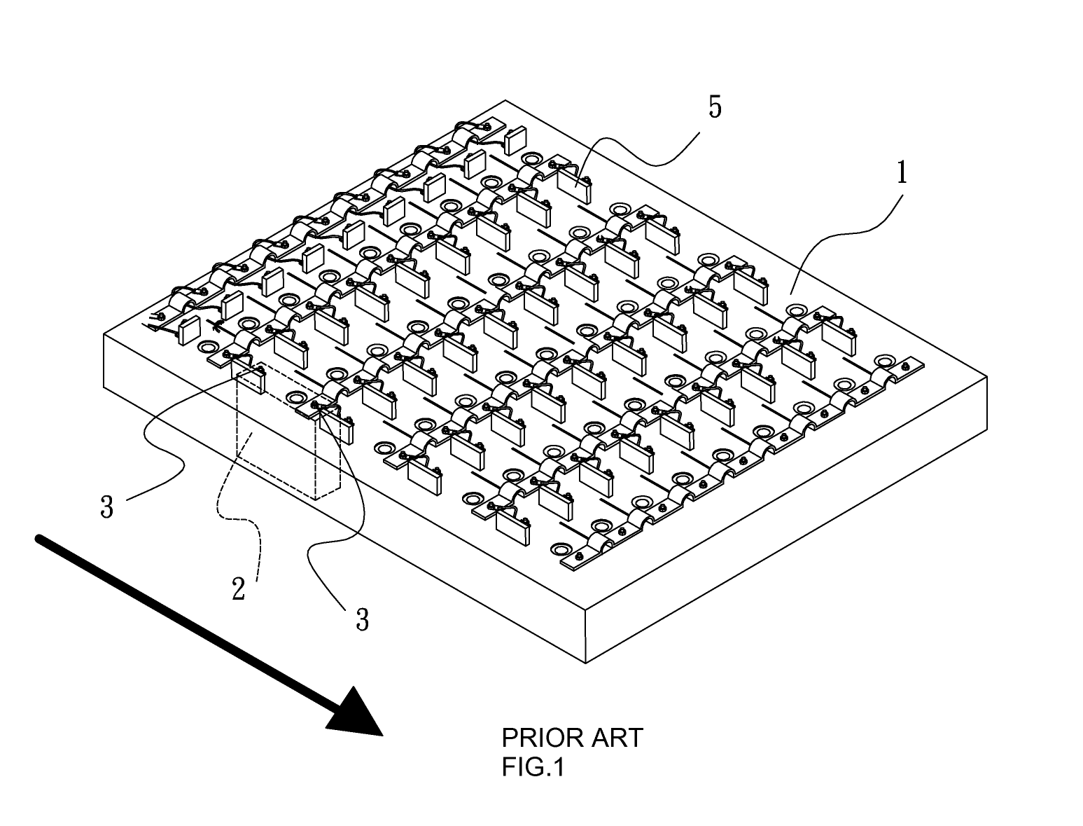

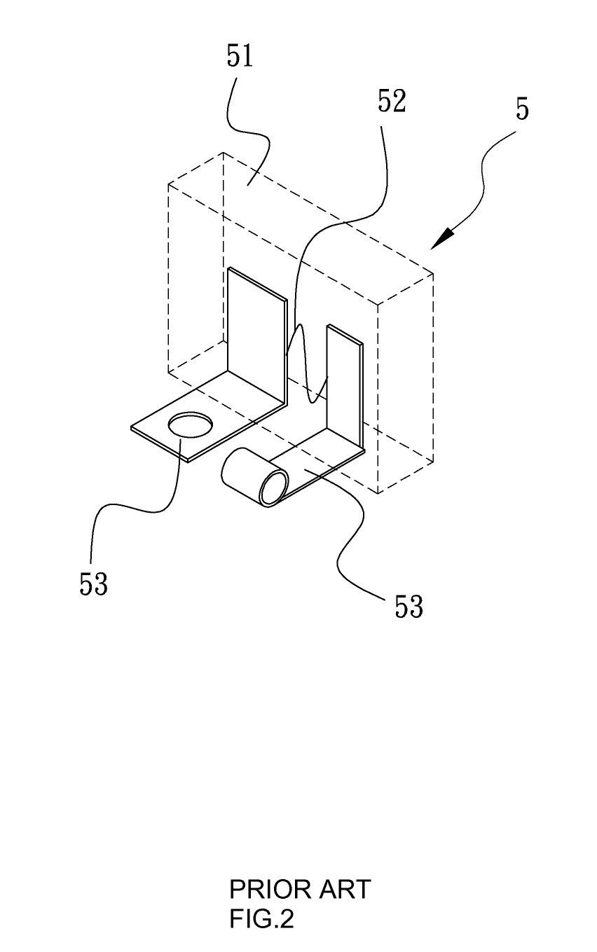

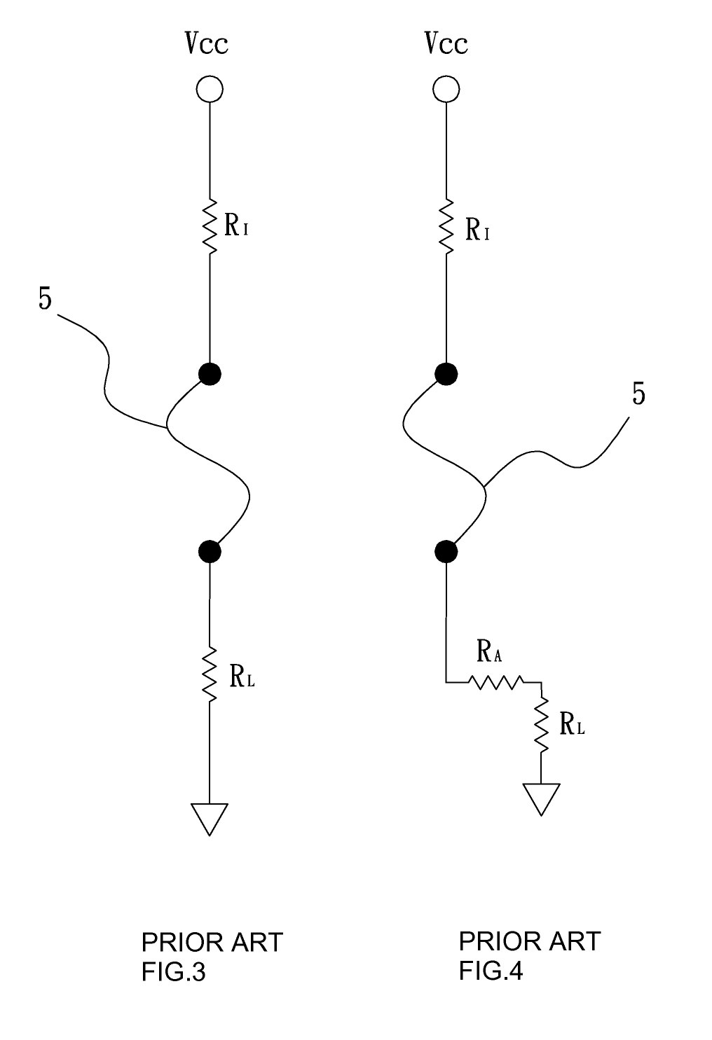

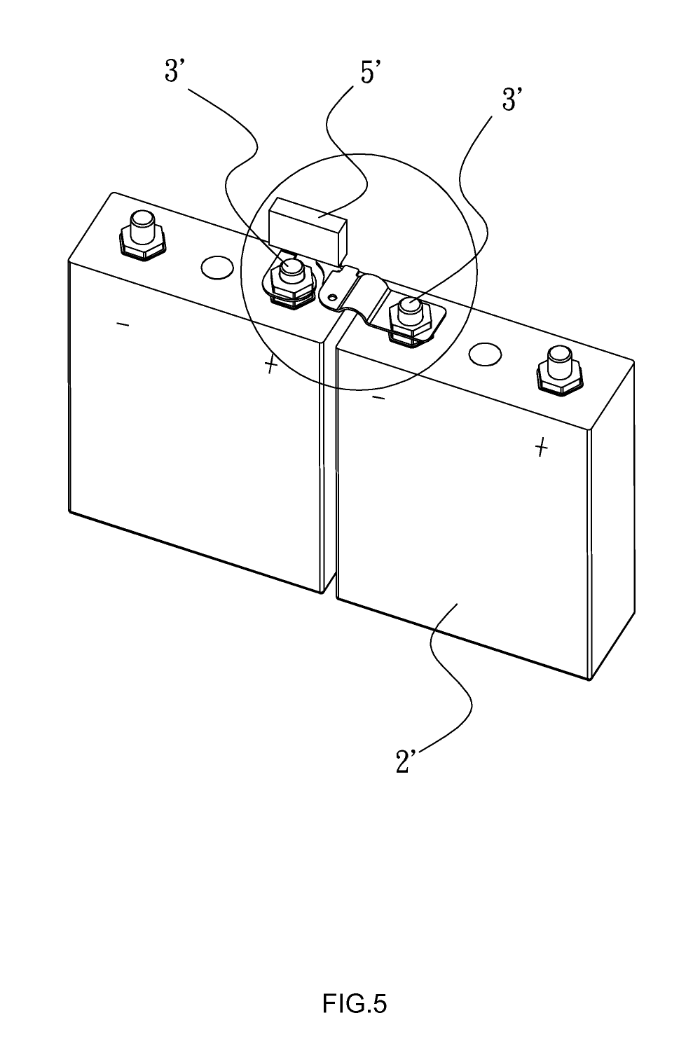

### DETAILED DESCRIPTION OF THE INVENTION

A fuse element having a damping structure according to the invention is illustrated herein to be mounted in a power source module. In this embodiment, an energy storage unit is illustrated as a battery pack composed of a single battery cell, and a single fuse element is connected correspondingly to a single battery cell. However, it is readily apparent to those skilled in the art that the arrangement described above is not limitative, and that a capacitor or an inductor may store energy in an electric field or in a magnetic field and serve as an energy storage unit for providing electric energy when needed. The fuse element according to the invention is also not limited to be used only in a power source module.

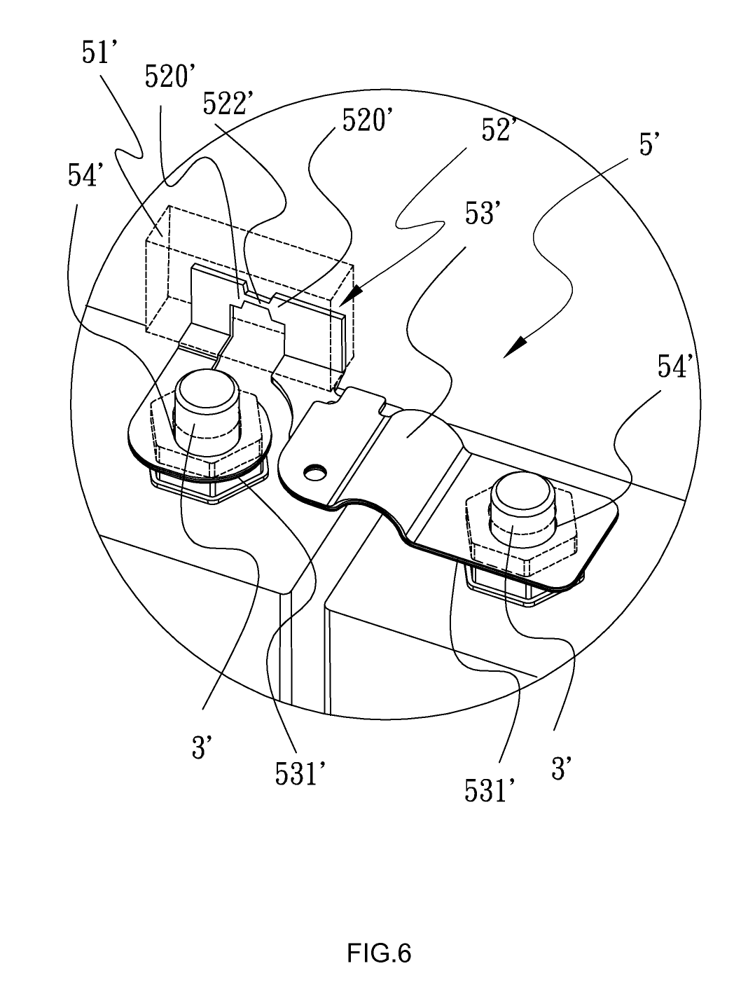

Referring to the first preferred embodiment shown in FIGS. 5 and 6, a fuse body 52′ includes two ends 522′ and a meltable portion 520′ which is coupled between the two ends 522′ and has a width narrower than that of the ends 522′. The fuse body 52′ is encapsulated by a housing 51′, so that in case the fuse body 52′ melts, the melted products will remain contained in the housing 51′ without being spread outwardly and contaminating the surrounding circuits.

In this embodiment, when two battery cells 2′ are electrically connected to each other, the fuse element 5′ is formed at both ends with a fixing hole 54′, through which an electrode 3′ of the corresponding battery cell 2′ may be inserted and fastened in position by a screw (not shown). In this embodiment, the fixing hole 54′ is formed at an enlarged end of an extending anchor section 53′ remote from the fuse body 52′. Therefore, in the case where the anchor section 53′ is formed of a plurality of very thin metal sheets 531′ laminated together and each of the metal sheets 531′ has a thickness much smaller than its surface area, the respective metal sheets 531′ are electrically connected between the fastened electrode 3′ and the fuse body 52′, and the anchor section 53′ exhibits both flexibility and conductivity. For clarity, a portion of the anchor section 53′ that exhibits both flexibility and conductivity is defined herein as a flexible conductive portion. If the power source module according to this embodiment is placed in a severely vibrating environment where the respective battery cells are vibrated in a disorganized manner, the respective flexible conductive portions will be subjected to the vibration and deformed temporarily. The flexible conductive portions therefore serve as a damping structure for alleviating the loosening problem of fastened screws caused by vibration.

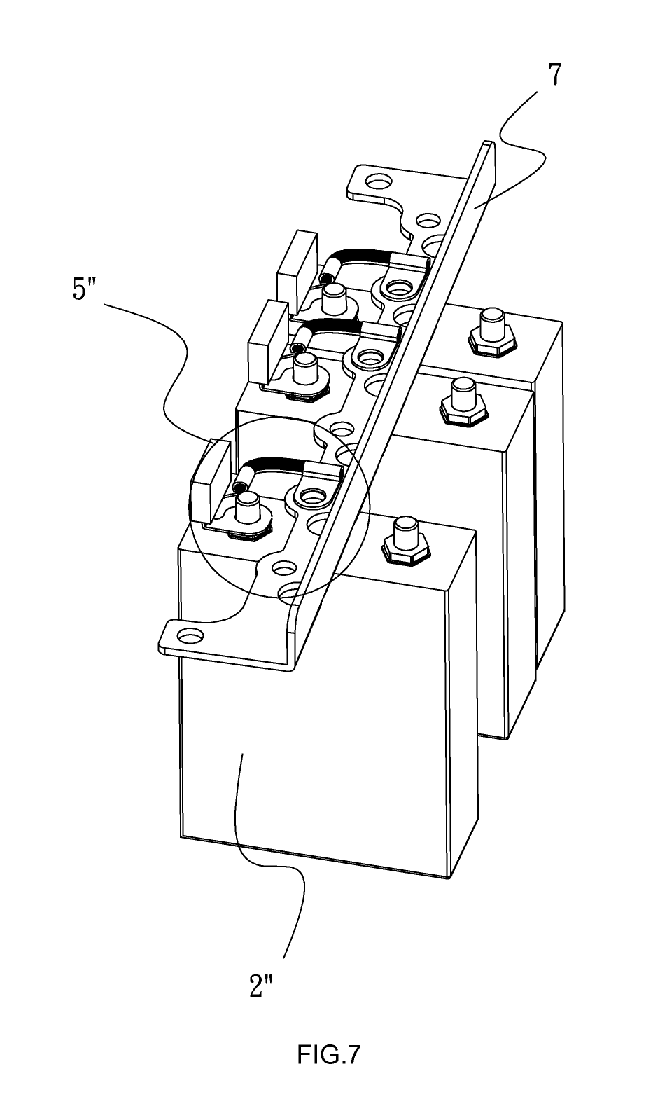

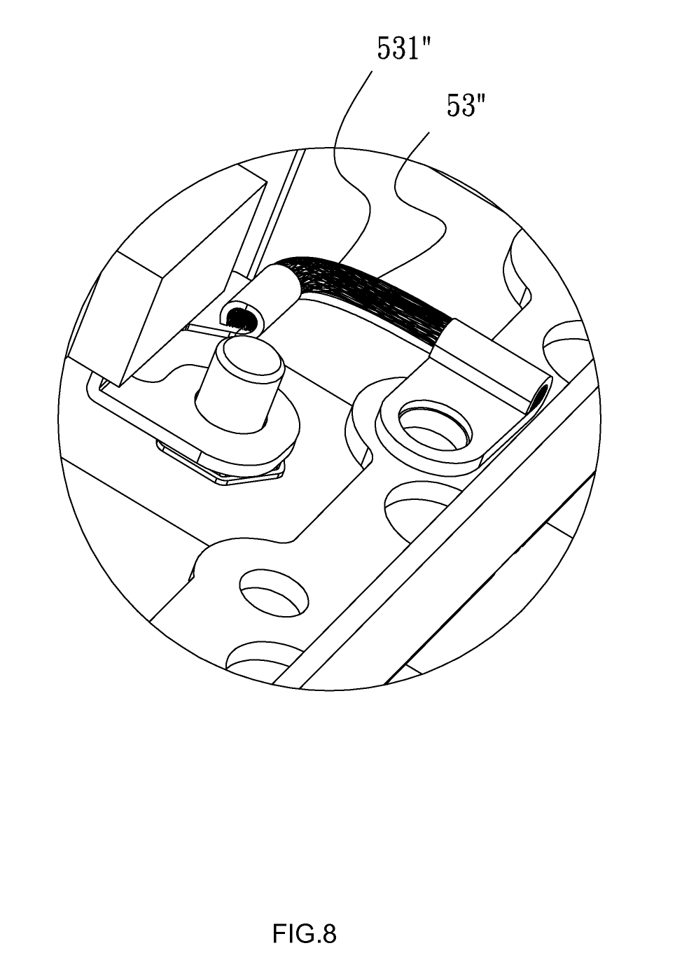

Instead of being configured to have an enlarged end formed with a fixing hole through which a screw may be inserted, the extending anchor sections may be configured to have a tab end for welding onto a welding terminal. Further, it is readily apparent to those skilled in the art that the damping effect intended by the invention can still be achieved, even though only one of the two anchor sections connected to the two ends of the fuse body is formed in part with the flexible conductive portion. A second preferred embodiment of the invention is shown in FIGS. 7 and 8, in which the battery cells are connected in parallel. Fuse elements 5″ are provided to electrically connect equivalent electrodes of respective battery cells 2″ to a conductive plate 7, so that the battery cells 2″ are arranged in parallel. The fuse element 5″ according to this embodiment includes an extending anchor section 53″, only a part of which is formed of a plurality of thin coated metal wires 531″ with high flexibility and conductivity and serves as a flexible conductive portion for absorbing the vibration occurring in the power source module to ensure a stable connection among battery cells.

By virtue of the technical features disclosed herein, a high-power power source such as that composed of hundreds of battery cells can be readily used in a vibrating environment. The invention ensures that a faulty battery cell can be disconnected from the system, while ensuring that functional battery cells remain working normally without being mistakenly disconnected from the system due to the loosening of fuse elements or breaking of the connection caused by vibration. The fuse element disclosed herein works well to monitor and protect circuit under any severely vibrating environment. The invention improves the reliability of the circuit and overcomes the problem of loosening of fuse elements and the mistaken disconnection of battery packs from the system and, hence, achieves the objects described above.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A fuse element having a damping structure comprising:
a fuse body including two ends and a meltable portion coupled between the two ends;
a housing for encapsulating the fuse body; and
two extending anchor sections, each being connected to one of the two ends, wherein at least one of the extending anchor sections has at least one flexible conductive portion.

2. The fuse element having a damping structure according to claim 1, wherein each of the extending anchor sections has an enlarged end formed with a fixing hole for connection to screw type terminals.

3. The fuse element having a damping structure according to claim 1, wherein the at least one flexible conductive portion is composed of a plurality of metal sheets laminated together.

4. The fuse element having a damping structure according to claim 1, wherein the at least one flexible conductive portion is composed of a plurality of metal wires.

5. The fuse element having a damping structure according to claim 1, wherein the meltable portion has a width narrower than that of the two ends.

6. The fuse element having a damping structure according to claim 1, wherein the fuse element is constructed with positive temperature coefficient resistor.

7. A power source module, comprising:
a plurality of energy storage units connected to one another in series or in parallel, each having two electrodes; and
an electrically conductive circuit for being electrically connected to the two electrodes of the energy storage units to arrange the energy storage units in series or in parallel, wherein the electrically conductive circuit is provided with a fuse element having a damping structure;
wherein the fuse element having a damping structure comprise:
a fuse body including two ends and a meltable portion coupled between the two ends;
a housing for encapsulating the fuse body; and
two extending anchor sections, each being connected to one of the two ends, wherein at least one of the extending anchor sections has at least one flexible conductive portion.

8. The power source module according to claim 7, wherein the at least one flexible conductive portion is composed of a plurality of metal sheets laminated together.

9. The power source module according to claim 7, wherein the at least one flexible conductive portion is composed of a plurality of metal wires.

10. The power source module according to claim 7, wherein each of the extending anchor sections has an enlarged end formed with a fixing hole, and wherein the meltable portion has a width narrower than that of the two ends.

11. The power source module according to claim 7, wherein the energy storage unit is a battery pack.
